(19) United States
(12) Patent Application Publication
(10) Pub. No.: US 2024/0366442 A1
(43) Pub. Date: Nov. 7, 2024

(54) PERCEPTION-BASED CONTROLLER FOR INGRESS, EGRESS, AND SECUREMENT OF A WHEELCHAIR IN A WHEELCHAIR ACCESSIBLE VEHICLE

(71) Applicants: The Braun Corporation, Winamac, IN (US); Valeda Company, LLC, Oakland Park, FL (US)

(72) Inventors: Michael Pugh, Carmel, IN (US); William Ott, Fort Lauderdale, FL (US); Adam Wojdyla, Winamac, IN (US); Daniel Tallitsch, Western Springs, IL (US)

(21) Appl. No.: 18/655,413

(22) Filed: May 6, 2024

Related U.S. Application Data
(60) Provisional application No. 63/500,312, filed on May 5, 2023.

(51) Int. Cl. A61G 3/06; A61G 3/08

(52) U.S. Cl. CPC A61G 3/061; A61G 3/0808; A61G 2203/10; A61G 2220/14

(57) ABSTRACT

A wheelchair accessible autonomous vehicle with improved interoperability between the ingress/egress doors, wheelchair access device, non-ingress/egress doors, and wheelchair securement system. Safety interlocks for those components may be automatically engaged and disengaged by vehicle computing systems during ingress and egress of a wheelchair based on input from one or more perception sensors associated with the vehicle, the ingress/egress doors, the non-ingress/egress doors, the wheelchair access device, the wheelchair securement system, and the wheelchair.

### CROSS REFERENCE TO RELATED APPLICATIONS

This application claims priority to U.S. Provisional Patent Application No. 63/500,312, filed May 5, 2023, the contents of which are incorporated herein by reference. This application also incorporates by reference the contents of PCT Patent Application No. PCT/US24/27916, filed May 6, 2024.

### FIELD OF THE DISCLOSURE

The subject technology provides solutions for improving wheelchair accessibility in autonomous vehicles (AVs) and in particular, for enabling automatic operation of a wheelchair access device, such as a ramp or lift, to facilitate the loading and unloading of a passenger seated in a wheelchair.

### BACKGROUND

The disclosures of U.S. Pat. No. 11,523,950 B2 and US. Patent Application Publications US2021/0370976A1 and US2022/0234627 A1 are incorporated herein in their entirety. As disclosed therein:

Autonomous vehicles (AVs) are vehicles having computers and control systems that perform driving and navigation tasks that are conventionally performed by a human driver. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. As AV technologies continue to advance, ride-sharing services will increasingly utilize AVs to improve service efficiency and safety. However, for effective use in ride-sharing deployments, AVs will be required to perform many of the functions that are conventionally performed by human drivers, such as performing navigation and routing tasks necessary to provide a safe and efficient ride service. Such tasks may require the collection and processing of large quantities of data using various sensor types, including but not limited to cameras and/or Light Detection and Ranging (LiDAR) sensors disposed on the AV.

For passengers who utilize wheelchairs, entering and exiting vehicles requires many different steps and procedures, including opening a door of the vehicle, deploying a ramp, securing/releasing the wheelchair in the cabin of the vehicle, stowing the ramp, closing the vehicle door, etc. In conventional ridesharing arrangements, human drivers assist passengers with accessibility into an out of the vehicle. For example, human drivers routinely help passengers load/unload and secure accessibility equipment, such as a wheelchairs and other mobility devices. Because human drivers are absent from autonomous vehicle (AV) deployments, there exists a need to provide automated support for the ingress/egress for passengers with special accessibility needs.

In addition, conventional rideshare vehicles are often used to provide rides to destinations with primary drop-off locations on private property. For example, drop-off locations can include hotel lobbies off the main road and houses at the end of long driveways. Additionally, businesses may have main drop-off zones on private property, and some locations may have preferred handicap entrances. However, autonomous vehicles generally do not travel on private property and do not have high fidelity maps of these locations.

Aspects of the prior art technology address the foregoing limitations by providing perception supporting hardware features that facilitate the loading and unloading (ingress/egress) of mobility devices, such as wheelchairs and/or personal scooters. In some aspects, the prior art technology includes AV sensors, e.g. cameras and/or Light Detection and Ranging (LiDAR) sensors that are configured to provide perception capabilities to the computing systems of the wheelchair accessible vehicle (WAV). In some prior art approaches, an AV of the disclosed technology can include reference markers that are disposed on or around certain AV features, such as on a wheelchair ramp, to facilitate AV perception of the accessibility equipment loading/unloading process. Additionally, a restraint system of the AV can be configured to automatically secure one or more pieces of equipment, such as a wheelchair, before a ride is commenced.

Other aspects of the prior art technology address the limitations of vehicles for wheelchair passengers by providing an application on a mobile device for wheelchair passengers to send requests to and/or control wheelchair-accessible systems on an autonomous vehicle. In some aspects of the prior art, a remote computing system may receive a request for a wheelchair-accessible autonomous vehicle (WAV) to execute an ingress function, such as deployment of a wheelchair ramp by the WAV. Furthermore, in response to the request, the remote computing system may send an ingress command to the WAV, such that the ingress command includes instructions to cause the WAV to execute the ingress function. Additionally, the remote computing system may receive feedback from the WAV indicating sensor data associated with the wheelchair ramp and status information associated with the ingress function.

Yet other aspects of the prior art technology provide systems and methods for user-specified location-based autonomous vehicle behavior zones. Public-facing tools can be provided for creation of custom behavior zones, providing a more tailored experience for passengers as well as businesses. Custom behavior zones allow passengers to request or select a specific pick-up/drop-off location on private property, including the identification of wheelchair-accessibility pick-up/drop-off locations.

FIG. 1 illustrates an example prior art system environment 100 that can be used to facilitate AV dispatch and operations, according to some aspects of both the prior art and presently disclosed technology. Autonomous vehicle 102 can navigate about roadways without a human driver based upon sensor signals output by sensor systems 104-106 of autonomous vehicle 102. Autonomous vehicle 102 includes a plurality of sensor systems 104-106 (a first sensor system 104 through an Nth sensor system 106). Sensor systems 104-106 are of different types and are arranged about the autonomous vehicle 102. For example, first sensor system 104 may be a camera sensor system and the Nth sensor system 106 may be a Light Detection and Ranging (LIDAR) sensor system. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it is contemplated in the prior art that more or fewer sensors may be coupled to the autonomous vehicle 102.

Autonomous vehicle 102 further includes several mechanical systems that are used to effectuate appropriate motion of the autonomous vehicle 102. For instance, the mechanical systems can include but are not limited to, vehicle propulsion system 130, braking system 132, and steering system 134. Vehicle propulsion system 130 may include an electric motor, an internal combustion engine, or both. The braking system 132 can include an engine brake, brake pads, actuators, and/or any other suitable componentry that is configured to assist in decelerating autonomous vehicle 102. In some cases, braking system 132 may charge a battery of the vehicle through regenerative braking. Steering system 134 includes suitable componentry that is configured to control the direction of movement of the autonomous vehicle 102 during navigation. Autonomous vehicle 102 further includes a safety system 136 that can include various lights and signal indicators, parking brake, airbags, etc. Autonomous vehicle 102 further includes a cabin system 138 that can include cabin temperature control systems, in-cabin entertainment systems, etc.

The autonomous vehicle 102 further includes a wheelchair accessibility system 140 that can include various electrical and mechanical systems including, but not limited to, doors, ramps, restraint systems, etc. Wheelchair accessibility system 140 is configured to assist passengers utilizing wheelchairs during ingress and egress of the autonomous vehicle 102.

Autonomous vehicle 102 additionally comprises an internal computing system 110 that is in communication with sensor systems 180 and systems 130, 132, 134, 136, and 138. Internal computing system 110 includes at least one processor and at least one memory having computer-executable instructions that are executed by the processor. The computer-executable instructions can make up one or more services responsible for controlling autonomous vehicle 102, communicating with remote computing system 150, receiving inputs from passengers or human co-pilots, logging metrics regarding data collected by sensor systems 180 and human co-pilots, etc.

Internal computing system 110 can include a control service 112 that is configured to control operation of vehicle propulsion system 130, braking system 132, steering system 134, safety system 136, and cabin system 138. Control service 112 receives sensor signals from sensor systems 180 as well communicates with other services of internal computing system 110 to effectuate operation of autonomous vehicle 102. In some embodiments, control service 112 may carry out operations in concert one or more other systems of autonomous vehicle 102. Internal computing system 110 can also include constraint service 114 to facilitate safe propulsion of autonomous vehicle 102. Constraint service 114 includes instructions for activating a constraint based on a rule-based restriction upon operation of autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of control service 112.

The internal computing system 110 can also include communication service 116. The communication service 116 can include both software and hardware elements for transmitting and receiving signals from/to the remote computing system 150. Communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions etc.

Internal computing system 110 can also include latency service 118. Latency service 118 can utilize timestamps on communications to and from remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, latency service 118 can enable other systems of autonomous vehicle 102 or a passenger to make necessary decisions or to provide the needed feedback.

Internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

Remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102. Remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

Remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

Remote computing system 150 can also include rideshare service 158 configured to interact with ridesharing applications 170 operating on (potential) passenger computing devices. Rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc. The ridesharing application 170 can also be configured to receive requests specifically for wheelchair-accessible autonomous vehicles 102. Similarly, ridesharing app 170 can also be configured to receive requests from a passenger for the autonomous vehicle 102 to perform a function and send the request to the rideshare service 158 of the remote computing system 150. The remote computing system 150 can then process the request and send commands to the communication service 116 of the internal computing system of the autonomous vehicle 102, so that the autonomous vehicle 102 can execute the request.

Remote computing system 150 can, in some cases, include at least one computing system 150 as illustrated in or discussed with respect to FIG. 10, or may include at least a subset of the components illustrated in FIG. 10 or discussed with respect to computing system 150.

FIG. 2 shows a prior art environment 200 in which an autonomous vehicle 102 has accessories to be wheelchair accessible. Accordingly, autonomous vehicle 102 is a wheelchair-accessible autonomous vehicle (WAV) 102. More specifically, WAV 102 has automatic doors 208, a wheelchair ramp 210, and a wheelchair restraint system 220. Thus, WAV 102 is configured to accommodate a wheelchair 250 of a passenger and/or a wheelchair passenger 250.

The automatic doors 208 are configured to receive commands from an internal computing system, such as the internal computing system 110, and/or a remote computing system, such as remote computing system 150. The doors 208 can, in response to receiving commands from the internal computing system and/or remote computing system, automatically open and/or close to allow passengers and objects to pass therethrough. For example, wheelchair passenger 250 may send, via an application on a mobile device, a request for the WAV to open doors to a remote computing system. In response to receiving the request, the remote computing system may then send a command to the internal computing system. In response to receiving the command, the internal computing system can then control the doors 208 to open and/or send a command to a system controlling the doors 208 to open the doors 208.

Like doors 208, wheelchair ramp 210 is configured to receive commands from the internal computing system 110 and/or the remote computing system 150. The wheelchair ramp 210 can, in response to receiving commands from the internal computing system and/or remote computing system, automatically load and/or unload to allow wheelchairs to be cross thereon.

Similarly, wheelchair restraint system 220 is configured to receive commands from the internal computing system 110 and/or the remote computing system 150. The wheelchair restraint system 220 can, in response to receiving commands from the internal computing system and/or remote computing system, automatically secure and/or release a wheelchair.

FIG. 3 and FIG. 4 show prior art environments 300a, 300b during various steps of restraining and/or securing the wheelchair 250.

More specifically, FIG. 3 illustrates the wheelchair and/or wheelchair passenger 250 in a cabin of the WAV 102. After the wheelchair passenger 250 has entered the cabin of the WAV 102, the ramp 210 may be loaded back onto WAV 102 and the doors 208 closed. Although not shown, the doors 208 may not be closed yet and/or the ramp may not be loaded yet. Although the wheelchair passenger 250 has entered the cabin of the WAV, the wheelchair restraint system 220 has not yet been engaged. The wheelchair passenger 250 may position the wheelchair in the cabin, such that the wheelchair restraint system 220 may, after being engaged, secure the wheelchair.

FIG. 4 illustrates the wheelchair and/or wheelchair passenger 250 secured by the wheelchair restraint system 220. Furthermore, wheelchair ramp 210 may be loaded back onto WAV 102 and the doors 208 closed. At this time, wheelchair passenger 250 may send information to WAV 102 indicating that the wheelchair passenger 250 is ready for WAV 102 to begin driving. In other words, after the wheelchair and/or wheelchair passenger 250 is properly secured by wheelchair restraint system 220, the doors 208 closed, and the wheelchair ramp 210 loaded, WAV 102 can begin driving.

FIG. 5 illustrates an example prior art accessibility system 200 that facilitates AV ingress/egress of a wheelchair, according to some aspects of both the prior art and presently disclosed technology. Accessibility system 200 includes communication module 202 that is communicatively coupled to ingress/egress perception module 204, and vehicle control module 206.

Communication module 202 can be responsible for receiving commands related to the operation of accessibility controls, such as to facilitate ingress/egress of a wheelchair ramp and/or enlist operations of an accompanying restraint system. By way of example, communications module 202 can be configured for communication with a mobile device and associated applications that can receive requests from a user/rider, and provide notifications to the rider. As such, communications module 202 can facilitate accessibility operations between wheelchair accessible AV, and various users/riders.

In turn, WAV ingress/egress perception module 204 can provide perception needed to track progress of the ingress/egress of accessibility equipment, such as by tracking progress in loading or unloading a wheelchair from an AV, for example, using a wheelchair ramp. As discussed in further detail below, perception functionalities performed by WAV ingress/egress perception module 204 can be facilitated by one or more visual cues/markers that are disposed at locations in the AV.

In conjunction with WAV vehicle controls module 206, WAV ingress/egress perception module 204 can provide functionality needed to automate the assistance process, for example by deploying a wheelchair ramp, tracking the progress of the conveyance of accessibility equipment into the AV, and securing the accessibility equipment using an automated restraint system (not shown).

FIG. 6 illustrates an example of a prior art automated wheelchair ingress/egress process 300. Process 300 begins with step 302 in which one or more visual reference features (e.g., one or more reflective markers) are identified (e.g. by a perception system of the AV) on at least one surface of the AV. In some approaches, multiple reference features of known locations can be used to ascertain the location of equipment within the AV, such as the deployment and retraction of a wheelchair ramp, as well as to track position/location information for one or more pieces of accessibility equipment and/or people boarding or exiting the AV cabin.

By way of example, location information may be ascertained about the wheelchair ramp position and/or a loading status of a wheelchair being loaded or unloaded from the AV based on visual obstructions between one or more of the reference features and one or more AV sensors (e.g. cameras and/or LiDAR sensors, etc.). Although visual markers can be used in some embodiments, it is contemplated in the prior art that the perception system of the prior art technology can be configured to perform tracking and location determinations using only AV sensors (e.g., cameras and/or LiDAR sensors, etc.).

In step 304, a ramp of the AV is automatically deployed to facilitate the ingress of one or more items of mobility equipment (e.g., a wheelchair). It is contemplated in the prior art that other aspects of the AV operation can also be automatically controlled, such as the opening and closing of one or more doors of the AV and/or the automatic harness/release of a restraint system, as discussed in further detail below.

In step 306, ingress of the mobility equipment (wheelchair) is tracked using the reference features. By way of example, visual obstruction of one or more reference features disposed on the wheelchair ramp may indicate a position of the wheelchair on the ramp. Tracking can also continue using one or more visual features that are disposed inside the AV cabin.

In step 308, the mobility equipment can be automatically secured within a cabin of the AV. Similar to step 306, the maneuver and automatic restraint of mobility equipment can be aided using location/position perception that is performed using one or more visual features. However, location/position tracking without the use of visual markers is contemplated. For example, tracking necessary to perform ingress/egress operations may be performed using AV sensor data that is provided to a machine-learning model.

FIG. 7 shows a prior art method 400 for assisting passenger ingress. Method 400 starts at step 402, in which a remote computing system receives a rideshare request to use a wheelchair-accessible autonomous vehicle (WAV). In some embodiments, the remote computing system receives and processes the rideshare request through a rideshare service, such as rideshare service 158.

At step 404, the remote computing system dispatches the WAV to a location of the passenger. In some embodiments, the remote computing system dispatches the WAV through a rideshare service, such as rideshare service 158. The WAV may receive the dispatch information through communication service 116. In some embodiments, the location of the passenger may be determined using location services, such as Global Positioning System (GPS), cellular networks, etc. Similarly, in some embodiments, the passenger may set the location. Accordingly, the location of the passenger may, in some scenarios, be different from an actual position of the passenger when the passenger submits the request.

At step 406, the remote computing system determines that the WAV has arrived at the location of the passenger. The remote computing system may utilize similar location services, cellular networks, etc. to determine a location of both the WAV and the location of the passenger.

At step 408, the remote computing system receives a request for the WAV to execute an ingress function. The request may be sent through a ridesharing application, such as ridesharing app 170. The request may then be received through a rideshare service, such as rideshare service 158. The remote computing system may then process the request and determine the ingress function. In some embodiments, the ingress function may include a deployment of a wheelchair ramp by the WAV and/or loading the wheelchair ramp after the passenger has boarded the WAV. Similarly, in some embodiments, the ingress function may include opening doors of the WAV and/or closing the doors of the WAV after the passenger has boarded the WAV. Likewise, in some embodiments, the ingress function may include engaging an automated restraint system configured to secure the wheelchair in the WAV. In some embodiments, the ingress function may be any combination of the above processes.

At step 410, the remote computing system sends an ingress command to the WAV in response to the request. In some embodiments, the remote computing system sends the command to the internal computing system of the WAV, which receives the command through a communication service, such as communication service 116. The ingress command comprises instructions to cause the WAV to execute the ingress function at a specified pick-up location, such as the location of the passenger.

At step 412, the remote computing system receives feedback from the WAV. As the WAV executes the ingress function, the WAV may send feedback to the remote computing system. In some embodiments, the WAV may send the feedback through a communication service, such as communication service 116. The feedback may include sensor data associated with a door to the WAV, a wheelchair ramp, and/or a wheelchair restraint system. For example, the sensor data may indicate that the wheelchair ramp is being unloaded. Similarly, the feedback may include status information associated with the ingress function. For example, the status information may indicate that a request has been received, that the WAV is executing the ingress function, that the WAV has completed the ingress function, that there is a fault state, etc.

At step 414, the remote computing system sends at least a portion of the feedback to the passenger of the WAV. In some embodiments, the remote computing system may send the feedback to the passenger through a rideshare service, such as rideshare service 158. Accordingly, the passenger will be aware of the status of the WAV executing the ingress function. In some embodiments, the remote computing system may send the status information associated with the ingress function to the passenger. In some embodiments, the remote computing system may send all of the feedback to the passenger.

In some embodiments, at step 416, the remote computing system determines that the status of the function includes a fault state. A fault state may be any state, in which the WAV is unable to complete the ingress function. For example, the WAV may include in the feedback, that a fault state has been detected because the sensors have detected an object passing by, such that the wheelchair ramp cannot be unloaded safely. As another example, the WAV may include in the feedback, that a fault state has been detected because the wheelchair should be moved a few inches to be properly restrained. Thus, the remote computing system can connect the passenger with a remote assistance operator. In some embodiments, the passenger may first resend the request. For example, the passenger may resent the request after moving the wheelchair in a suggested direction to be properly restrained. In some embodiments, the remote computing system may automatically connect the passenger with the remote assistance operator. The remote assistance operator may assist the passenger remotely. For example, the remote assistance operator may receive additional sensor data to determine the cause of the fault state. The remote assistance operator may then remotely send commands to the WAV to complete the ingress function.

At step 418, the remote computing system receives information from the passenger indicating readiness for the WAV to begin driving. In some embodiments, after the passenger has boarded the WAV and the wheelchair is properly secured and/or restrained, the passenger may send information to the remote computing system and/or the internal computing system of the WAV. In some embodiments, the passenger may send the information through a rideshare app, such as rideshare app 170, on the mobile device of the passenger. In some embodiments, the WAV may have sensors in the cabin of the vehicle to determine that the passenger is ready. For example, the WAV may have microphones, such that the WAV may determine that the passenger is ready if the passenger says, “I am ready.” In some embodiments, the ingress functions may include loading the ramp and closing the doors. In other embodiments, the internal computing system may, in response to determining that the passenger is ready, load the ramp, close the doors, and/or secure the wheelchair.

FIG. 8 shows a prior art method 500 for assisting passenger egress. It is contemplated in the prior art that method 500 may be used in conjunction with method 400 and/or alone. Method 500 starts at step 502, in which the remote computing system determines that the WAV has arrived at a destination. The remote computing system may utilize similar location services, cellular networks, etc. to determine a location of both the WAV and the location of the destination.

At step 504, the remote computing system sends an egress command to the WAV. The egress command includes egress instructions to cause the WAV to execute an egress function. In some embodiments, the remote computing system may send the egress command in response to receiving a request for the WAV to execute the egress function. The request may be sent through a ridesharing application, such as ridesharing app 170. The request may then be received through a rideshare service, such as rideshare service 158. The remote computing system may then process the request and determine the egress function. In some embodiments, the egress function may include a deployment of a wheelchair ramp by the WAV and/or loading the wheelchair ramp after the passenger has exited the WAV. Similarly, in some embodiments, the egress function may include opening doors of the WAV and/or closing the doors of the WAV after the passenger has exited the WAV. Likewise, in some embodiments, the egress function may include disengaging an automated restraint system configured to release the wheelchair in the WAV. In some embodiments, the egress function may be any combination of the above processes. In some embodiments, the remote computing system sends the command to the internal computing system of the WAV, which receives the egress command through a communication service, such as communication service 116. The egress command comprises instructions to cause the WAV to execute the egress function at a specified drop-off location, such as the destination.

At step 506, the remote computing system receives egress feedback from the WAV. As the WAV executes the egress function, the WAV may send egress feedback to the remote computing system. In some embodiments, the WAV may send the egress feedback through a communication service, such as communication service 116. The egress feedback may include egress sensor data associated with a door to the WAV, a wheelchair ramp, and/or a wheelchair restraint system. For example, the egress sensor data may indicate that the wheelchair ramp is being unloaded. Similarly, the egress feedback may include status information associated with the egress function. For example, the status information may indicate that a request has been received, that the WAV is executing the egress function, that the WAV has completed the egress function, that there is a fault state, etc.

At step 508, the remote computing system sends at least a portion of the egress feedback to the passenger of the WAV. In some embodiments, the remote computing system may send the egress feedback to the passenger through a rideshare service, such as rideshare service 158. Accordingly, the passenger will be aware of the status of the WAV executing the egress function. In some embodiments, the remote computing system may send the status information associated with the egress function to the passenger. In some embodiments, the remote computing system may send all of the feedback to the passenger.

In some embodiments, at step 510, the remote computing system determines that the status of the egress function includes a fault state. A fault state may be any state, in which the WAV is unable to complete the egress function. For example, the WAV may include in the egress feedback, that a fault state has been detected because the sensors have detected an object passing by, such that the wheelchair ramp cannot be unloaded safely. Thus, the remote computing system connects the passenger with a remote assistance operator. In some embodiments, the passenger may first resend the request. In some embodiments, the remote computing system may automatically connect the passenger with the remote assistance operator. The remote assistance operator may assist the passenger remotely. For example, the remote assistance operator may receive additional sensor data to determine the cause of the fault state. The remote assistance operator may then remotely send commands to the WAV to complete the egress function.

At step 512, the remote computing system receives information from the passenger indicating egress. In other words, the remote computing system receives information from the passenger that the passenger has fully disembarked from the WAV. In some embodiments, after the passenger has exited the WAV, the passenger may send information to the remote computing system and/or the internal computing system of the WAV. In some embodiments, the passenger may send the information through a rideshare app, such as rideshare app 170, on the mobile device of the passenger. In some embodiments, the WAV may have sensors on an exterior of the cabin of the vehicle to determine that the passenger has disembarked from the WAV. For example, the WAV may have cameras on an exterior of the WAV, such that the WAV may determine that the passenger has deboarded when the cameras detect the wheelchair has moved away from the wheelchair ramp. The WAV may then load the wheelchair ramp, close the doors, and begin a new rideshare journey.

FIG. 9 shows a map 600 of a property 602 for custom defining a behavior zone, according to some embodiments of the prior art. In particular, the map 600 shows a property 602 including a building 620 that has a main doorway 612 and a service doorway 616. Additionally, the map 600 shows a ramp 610 to the main door 612, with the bottom of the ramp marked as a wheelchair-accessible drop off location 608.

According to some implementations of the prior art, when a user accesses the map 600 through a portal and/or application, the user selects what type of behavior zone the user would like to add. In the map 600, the user may request to add alternative pick-up/drop-off locations and a wheelchair-accessible pick-up/drop-off location. If the main door entrance is a loading zone (no parking allowed), the user may request to add a loading zone identification. After identifying the type of behavior zone to be added, the user is asked to identify selected locations and to mark certain routes on the map 600.

In particular, to add the wheelchair-accessible pick-up/drop-off location 608, the user selects the corresponding behavior zone type, and then identifies the location 608 on the map 600. Additionally, if the mapping system for the behavior zones does not yet have the entry 604, the driveway 606, and/or the exit 614 mapped, the user will be prompted to identify these locations. After identifying the locations of the entry 604 and the exit 614, the user may be prompted to draw on the map 600 the route 606 from the entry 604 to the exit 614.

Other pick-up/drop/off locations may also be added to the map 600. To add other pick-up/drop-off locations, the user selects the corresponding behavior zone type (e.g., “alternative pick-up/drop-off location”), and then identifies the main door location 612 on the map 600. The user may also choose to identify the service entrance 616.

In some examples, the user can specify where vehicles should wait to pick-up a passenger. In particular, on the map 600, the standing area 618 is a space for vehicles to stand while awaiting passengers. The user can identify the standing area 618 on the map 600 by drawing an outline or circle around the area 618.

FIG. 10 illustrates an example prior art processor-based system with which some aspects of both the prior art and presently disclosed technology can be implemented. For example, processor-based system 700 that can be any computing device making up internal computing system 110, remote computing system 150 and/or a passenger device executing the rideshare app 170, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710.

Computing system 700 can include a cache of high-speed memory 712 connected directly with, in close proximity to, and/or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 10 illustrates an example prior art processor-based system with which some aspects of the prior art and presently disclosed technology can be implemented. Specifically, FIG. 10 illustrates system architecture 700 wherein the components of the system are in electrical communication with each other using a bus 705. System architecture 700 can include a processing unit (CPU or processor) 710, as well as a cache 712, that are variously coupled to system bus 705. Bus 705 couples various system components including system memory 715, (e.g., read only memory (ROM) 720 and random access memory (RAM) 725, to processor 710.

System architecture 700 can include a cache of high-speed memory connected directly with, in close proximity to, or integrated as part of the processor 710. System architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. Memory 715 can include multiple different types of memory with different performance characteristics. Processor 710 can include any general purpose processor and a hardware module or software module, such as module 1 (732), module 2 (734), and module 3 (736) stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms. In some instances, multimodal systems can enable a user to provide multiple types of input to communicate with the computing system architecture 700. Communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 can include software modules 732, 734, 736 for controlling processor 710. Other hardware or software modules are contemplated. Storage device 730 can be connected to the system bus 705. In one aspect, a hardware module that performs a particular function can include the software component stored in a computer-readable medium in connection with the necessary hardware components, such as the processor 710, bus 705, output device 735, and so forth, to carry out various functions of the disclosed technology.

Embodiments within the scope of the prior art and present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the prior art and present disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

### SUMMARY OF THE EMBODIMENTS

While the prior art disclosures cited herein contemplate “automatic” operation of doors, a ramp, and a wheelchair securement system in a wheelchair accessible vehicle, the disclosures are vague in many respects and lack sufficient disclosure to make and safely use an autonomous wheelchair accessible vehicle. As one example, the prior art disclosures do not include or contemplate safeguards or other logic to ensure that a wheelchair passenger cannot exit the vehicle before the ramp is fully deployed or through a door opening that lacks a ramp altogether. The present disclosure addresses these shortcomings of the cited prior art.

In one embodiment, a system is provided for facilitating ingress and egress of a wheelchair in a wheelchair accessible vehicle. The system may include: one or more processors; at least one door being moveable between an open position and a closed position; a wheelchair access device associated with one of the at least one door and being moveable between a deployed position and a stowed position; a wheelchair securement system for securing at least one of the wheelchair and a wheelchair passenger and having a secured condition and an unsecured condition; and, a non-transitory computer-readable medium coupled to the one or more processors. The computer readable medium can include instructions, which when executed by the one or more processors, cause the one or more processors to perform operations comprising: monitoring at least one of a vehicle status, a door status, a wheelchair access device status, a wheelchair securement system status, and a wheelchair status, wherein the wheelchair status comprises at least one of a location, a speed, and a direction of the wheelchair; and, initiating at least one interlock function that locks or unlocks at least one of the wheelchair accessible vehicle, one of the at least one doors, the wheelchair access device, and the wheelchair securement system based at least in part upon at least one of (a) the wheelchair status, (b) the door status, (c) the wheelchair access device status, (d) the wheelchair securement system status, and (e) the vehicle status.

In another embodiment, a computer-implemented method may be provided to perform the above-described operation.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates a system environment that can be used to facilitate AV navigation and routing operations, according to some aspects of the prior art and presently disclosed technology.

FIG. 2 illustrates an environment that includes a passenger entering a wheelchair-accessible autonomous vehicle, according to some aspects of the prior art and presently disclosed technology.

FIG. 3 and FIG. 4 illustrate environments during various steps of a passenger entering a wheelchair-accessible autonomous vehicle, according to some aspects of the prior art and presently disclosed technology.

FIG. 5 illustrates an accessibility system that facilitates AV ingress/egress of a wheelchair, according to some aspects of the prior art and presently disclosed technology.

FIG. 6 illustrates a prior art automated wheelchair ingress/egress process.

FIG. 7 illustrates a method for a passenger ingress process, according to some aspects of the prior art and presently disclosed technology.

FIG. 8 illustrates a method for a passenger egress process, according to some aspects of the prior art and presently disclosed technology.

FIG. 9 is a diagram illustrating a map of a property for defining a behavior zone, including a wheelchair pick-up/drop-off location, according to some embodiments of the prior art and present disclosure.

FIG. 10 illustrates a processor-based system with which some aspects of the prior art and

presently disclosed technology can be implemented.

FIG. 11 illustrates an example environment in which the wheelchair accessible autonomous vehicle 102 of FIGS. 1-10 includes improved interoperability between and safety interlocks for the ingress/egress doors 208, ramp (or, more broadly, a wheelchair access device) 210, non-ingress/egress doors 209, and wheelchair securement system 220.

FIG. 12 is a simplified flow diagram illustrating an example wheelchair ingress operation for the wheelchair accessibility system in the wheelchair accessible autonomous vehicle 102 of FIGS. 1-11.

FIG. 13 is a simplified flow diagram illustrating an example wheelchair egress operation for the wheelchair accessibility system in the wheelchair accessible autonomous vehicle 102 of FIGS. 1-11.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

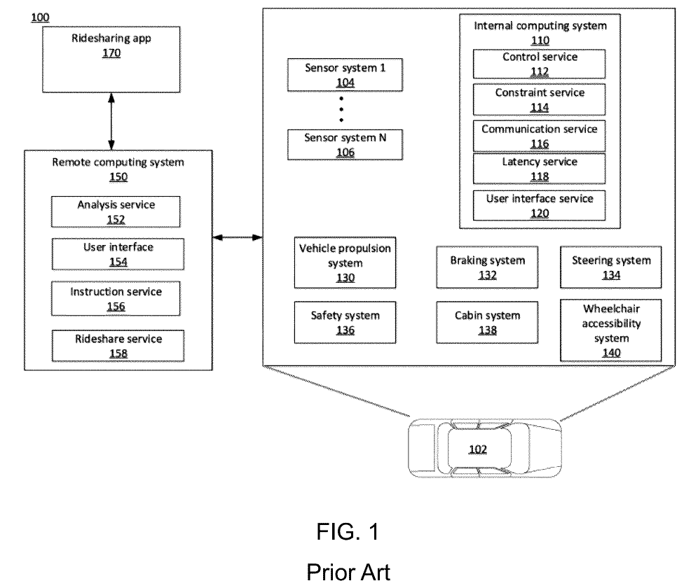

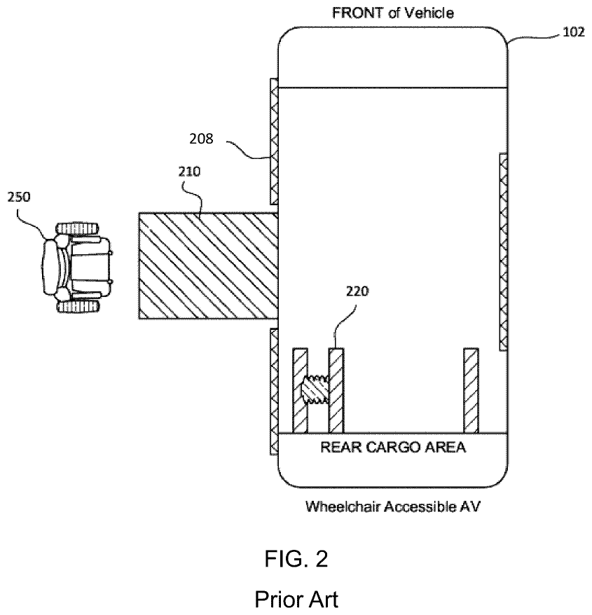

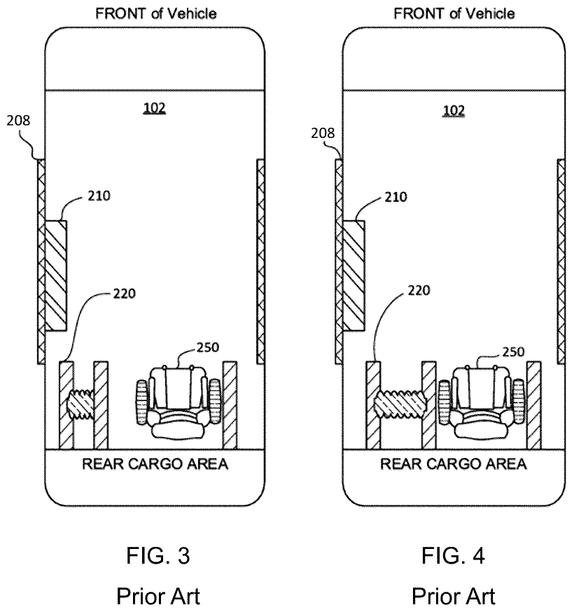

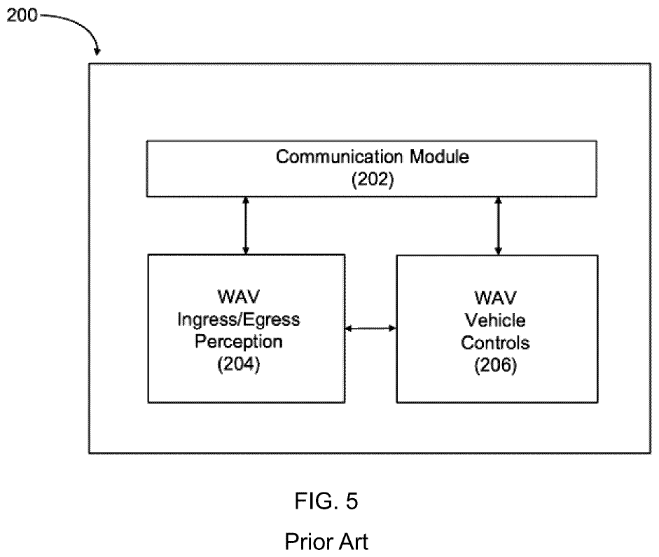

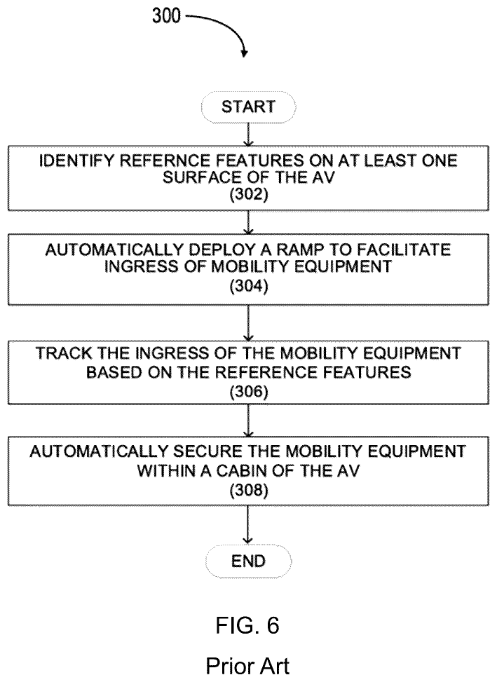

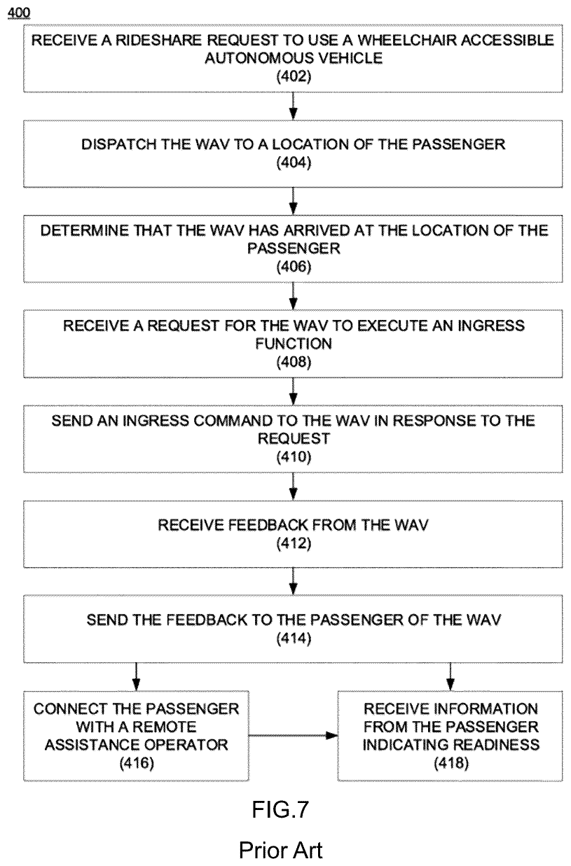

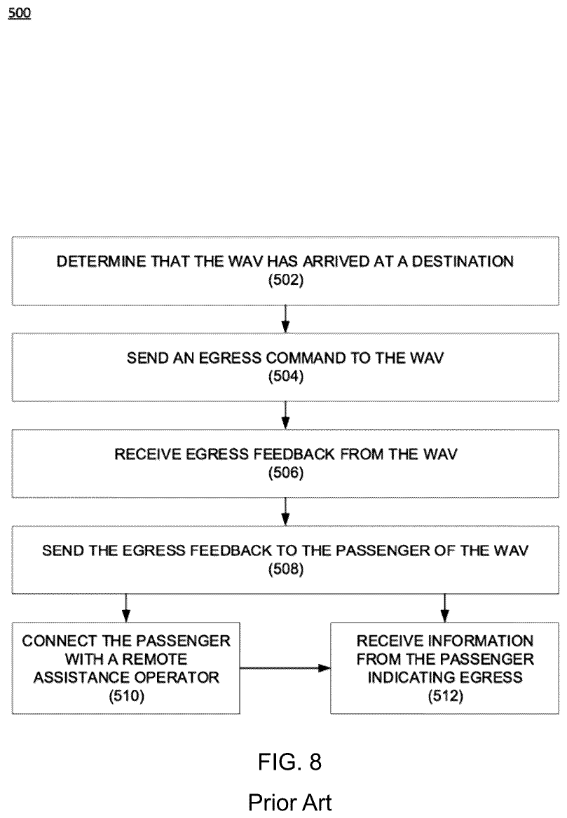

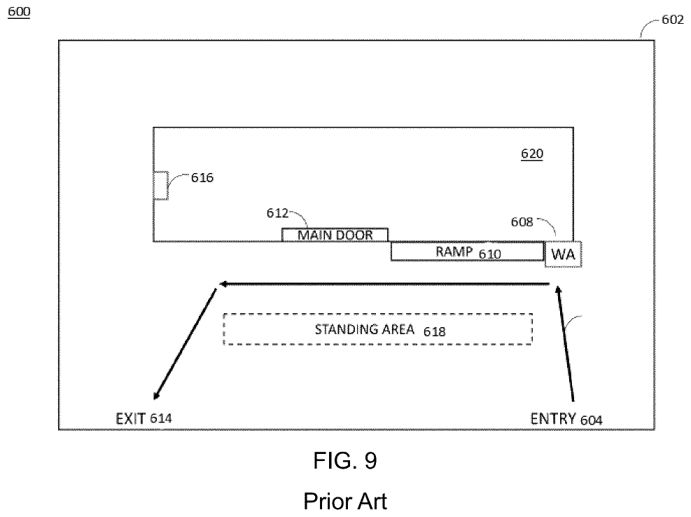

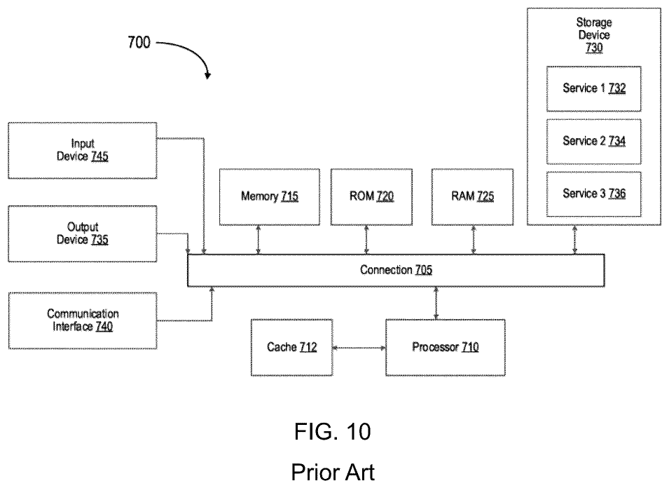

FIGS. 1-10 illustrate various prior art systems, environments, and processes for accommodating a wheelchair passenger 250 in an example autonomous vehicle (AV) 102. These prior art embodiments contemplate use of an accessibility system 200 and ingress/egress processes and methods 300, 400, 500 to track wheelchair 250 ingress/egress and enable “automatic” operation of doors 208, a ramp 210, and a wheelchair securement system 220 in a wheelchair accessible vehicle. However, the prior art embodiments suffer from various drawbacks that prevent safe use of the doors 208 and ramp 210 when a wheelchair 250 is present in the vehicle 102. For instance, the prior art disclosures cited herein do not include or contemplate safeguards or other logic to ensure that a wheelchair passenger cannot exit the vehicle before the ramp 210 is fully deployed or through a door 208 opening that lacks a ramp altogether. The present disclosure addresses these shortcomings of the cited prior art by providing appropriate safeguards, logic, and interlocks for the doors 208, ramp 210, and wheelchair securement system 220 to prevent the wheelchair passenger 250 from inadvertently exiting the vehicle through the door 208 opening before the ramp 210 has fully deployed or through the other door openings in the vehicle 102 that lack a ramp or other wheelchair access device.

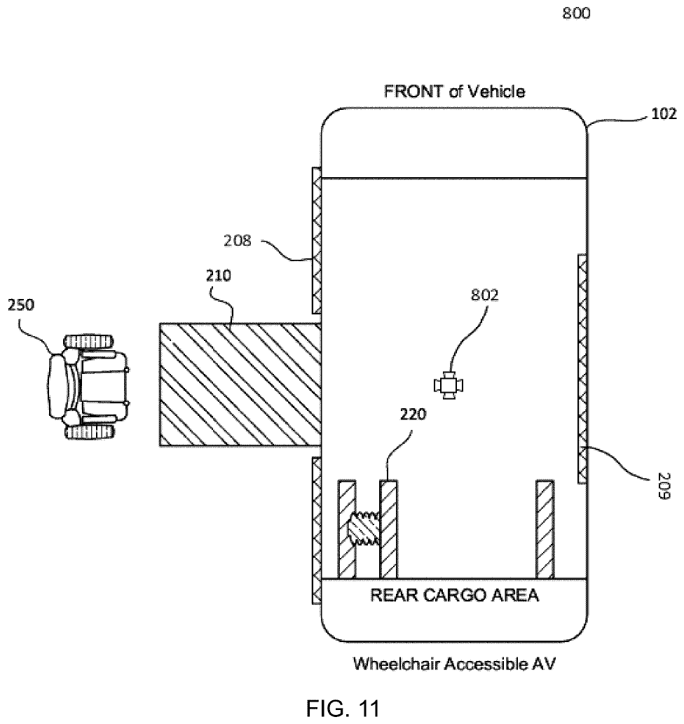

FIG. 11 illustrates an example environment 800, in which the wheelchair accessible autonomous vehicle 102 of FIGS. 1-10 includes improved interoperability between and safety interlocks for the ingress/egress doors 208, ramp (or, more broadly, a wheelchair access device) 210, non-ingress/egress doors 209, and wheelchair securement system 220. It is contemplated that the safety interlocks may be applied within any of the individual systems of the vehicle, e.g. systems 130, 132, 134, 136, 138, 140, and/or within the constraint service 114 of the internal computing system 110.

The vehicle 102 may be provided with at least one perception sensor 802 that is positioned to track at least one of the location, speed, and direction of movement of the wheelchair 250 in and outside of the vehicle. The perception sensor 802 may take form as a single sensor or multiple sensors comprising one or more of any of the following: the camera sensor system 104, the Light Detection and Ranging sensor system (LIDAR) 106, and the other exemplary sensor systems described in the Background section above (e.g., RADAR, EmDAR, SONAR, SODAR, GNSS, GPS, accelerometers, gyroscopes, IMU, infrared, laser, ultrasonic, infrasonic sensor systems, microphones, etc.) and a Time-of-Flight sensor (ToF). The perception sensor 802 may be mounted internal to the cabin of the vehicle (e.g., in the ceiling, the opposite wall or door, or a pillar of the vehicle, etc.) and/or external to the vehicle (e.g., above, to either side, or below the door opening, etc.). The perception sensor 802 may include a wide field of view and may be capable of monitoring not only the inside of the vehicle, but also at least a large fraction of the region occupied by the wheelchair access device 210 in the deployed and/or stowed positions but also regions surrounding the wheelchair access device 210.

The internal computing system 110 of the vehicle may be in communication with and receive input from the perception sensor 802 and/or other sensors associated with the vehicle 102, ingress/egress door(s) 208, the non-ingress/egress door(s) 209, the wheelchair access device 210, and wheelchair securement system 220. The internal computing system 110 processor may execute instructions (e.g., machine learning software/algorithms and/or methods/processes/logic) stored in the memory to receive and process the input, determine the status of the vehicle 102 (e.g., at pick-up location, at drop-off location, moving, stationary, etc.), determine the status of the wheelchair passenger 250 (e.g., one or more of location, speed, direction, in the vehicle, in the wheelchair securement area, outside of the wheelchair securement area, on the wheelchair access device, off the wheelchair access device, outside of the vehicle, moving, stationary, approaching the wheelchair access device for ingress, moving away from the wheelchair access device after ingress, approaching the wheelchair access device for egress, moving away from the wheelchair access device after egress, approaching the wheelchair securement station for securement, departing from the wheelchair securement station for egress), determine the status of the ingress/egress door(s) and non-ingress/egress door(s) 208, 209 (e.g., fully open, between open and closed, moving, stationary, fully closed, obstructed, fault), determine the status of the wheelchair access device (e.g., deployed, stowed, between deployed and stowed, moving, stationary, obstructed, fault), determine the status of the wheelchair securement system 220 (e.g., wheelchair secured, wheelchair released, between secured and released, moving, stationary, obstructed, fault, passenger secured, passenger unsecured, between passenger secured and unsecured), issue instructions for the door(s) 208, 209 to open or close, issue instructions for the wheelchair access device 210 to deploy or stow, issue instructions for the wheelchair securement system 200 to secure or release the wheelchair 250, and initiate interlocks preventing operation of any one or more of the vehicle 102, the ingress/egress door 208, the non-ingress/egress door 209, wheelchair access device 210, and wheelchair securement system 220. The interlocks may be based on any one or more of the location of the wheelchair, the direction of the wheelchair, the speed of the wheelchair, the status of the wheelchair securement system 220, the status of the non-ingress/egress door 209, the status of the ingress/egress door 208, the status of the wheelchair access device 210, and the status of the vehicle 102.

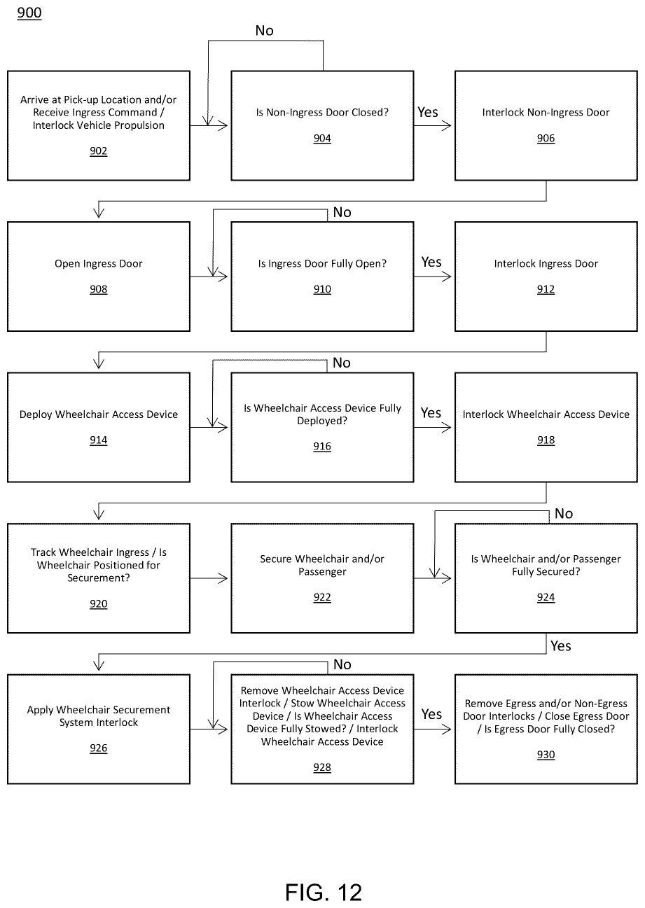

FIG. 12 is a simplified flow diagram illustrating example wheelchair ingress operation 900 that may be performed by one or more of the computing systems, e.g., remote computing system 150, internal computing system 110, and/or a separate computing system for the wheelchair accessibility system 140, in the wheelchair accessible autonomous vehicle 102 of FIGS. 1-11. Any combination of the steps in operation 900 may be used in a given application, and those steps may be performed in any order. Moreover, it is contemplated that the computing system can be configured to automatically proceed from step to step upon satisfaction of the conditions prescribed for the preceding step and without human interaction or input.

Example wheelchair ingress operation 900 starts at step 902, in which the computing system determines that the vehicle 102 has arrived at the wheelchair passenger's 250 pick-up location and automatically proceeds to step 904. In some embodiments, an interlock may be initiated preventing the vehicle 102 from moving for the remainder of the ingress operation 900, before step 908 when the ingress door is opened. In some embodiments, the computing system may also require receiving an ingress request or command from the wheelchair passenger 250 before automatically proceeding to step 904. It is contemplated that an ingress command can comprise a request to secure the wheelchair 250 and/or wheelchair passenger 250, to open the ingress door 208, or to deploy the wheelchair access device 210.

At step 904, the computing system automatically checks the status of the non-ingress door 209 to confirm that the non-ingress door 209 is fully closed. If not, the computing system may automatically issue a command for the non-ingress door 209 to close. In any event, the computing system may, perhaps spaced apart by predetermined periods of time, repeatedly or continuously check the status of the non-ingress door 209 and only automatically proceeds to step 906 when the closed status of the non-ingress door 209 is confirmed. For the avoidance of doubt, the non-ingress door 209 is any door in a vehicle through which the wheelchair passenger is not intended to enter. In some cases, a vehicle may have multiple doors that are wheelchair accessible. For purposes of this hypothetical vehicle, the accessible door through which the passenger is intended to enter at a specific destination is referred to herein as the ingress door, while the remaining door(s) (whether wheelchair accessible or not) are collectively referred to as the non-ingress door.

At step 906, the computing system automatically interlocks the non-ingress door 209 to prevent the door 209 from opening for at least a portion of the ingress operation 900. For example, the computing system may be configured to automatically reject any command or request to open the non-ingress door 209 and/or provide feedback or other warning to the vehicle occupants that an unsafe condition has been requested, in which case the vehicle occupant can be given the option to override the interlock. Interlocking the non-ingress door 209 prevents an unsecured wheelchair 250 from exiting through an unintended door, which could be on the traffic side of the vehicle, and/or through a door lacking a wheelchair access device.

At step 908, the computing system automatically commands the ingress door 208 to open. At step 910, perhaps after a predetermined period of time, the computing system checks the status of the ingress door 208 to confirm that the ingress door 208 is fully open. If not, the computing system may automatically issue another command for the ingress door 208 to open. In any event, the computing system may, perhaps spaced apart by predetermined periods of time, repeatedly or continuously check the status of the ingress door 208 and only proceeds to step 912 when the open status of the ingress door 208 is confirmed.

At step 912, to prevent undesirable interference between the ingress door 208 and the wheelchair access device 210, the computing system automatically interlocks the ingress door 208 to prevent the door 209 from closing for at least a portion of the ingress operation 900. For example, the computing system may be configured to reject any command or request to close the ingress door 208 and/or provide feedback or other warning to the vehicle occupants that the door 208 cannot be closed while the wheelchair access device 210 is deployed or deploying, in which case the vehicle occupant can be given the option to stow the wheelchair access device 210 and override the interlock.

At step 914, the computing system automatically commands the wheelchair access device 210 to deploy. If necessary, the computing system will first remove any interlocks for the wheelchair access device 210 that may prevent its operation. Additionally, prior to removing that interlock and/or issuing that command, the computing system may confirm that the ingress door 208 and wheelchair access device 210 are clear of other passengers or other obstructions. While the wheelchair access device 210 is moving, the computing system may continue to monitor the area surrounding the ingress door 208 and/or the wheelchair access device 210 to ensure that they remain clear of passengers or other obstructions. See, for example, U.S. Patent Application No. 63/484,000, filed on Feb. 9, 2023, which discloses a perception based obstruction detection system that may be employed for these purposes and is incorporated herein by reference. The computing system may also monitor vehicle occupants and/or persons outside the vehicle for movement that suggests a person is moving toward the ingress door 208 and, responsive thereto, stop operation of the wheelchair access device 210. For the avoidance of doubt, for the ingress operation 900, it is contemplated that the deployed position of a wheelchair access device is the position in which the wheelchair passenger 250 can safely be received by the wheelchair access device 210 from ground level.

At step 916, perhaps after a predetermined period of time, the computing system checks the status of the wheelchair access device 210 to confirm that the wheelchair access device 210 is fully deployed. If not, the computing system may automatically issue another command for the wheelchair access device 210 to deploy. In any event, the computing system may, perhaps spaced apart by predetermined periods of time, repeatedly or continuously check the status of the wheelchair access device 210 and only proceeds to step 918 when the deployed status of the wheelchair access device 208 is confirmed.

At step 918, the computing system automatically interlocks the wheelchair access device 210 to prevent the wheelchair access device 210 from moving and/or stowing for at least a portion of the ingress operation 900. For example, the computing system may be configured to reject or ignore any command or request to stow the wheelchair access device 210 and/or provide feedback or other warning to the vehicle occupants that an unsafe condition has been requested, in which case the vehicle occupant can be given the option to override the interlock. Interlocking the wheelchair access device 210 prevents an unsecured wheelchair 250 from exiting through the ingress door 208 without the wheelchair access device 210 in its fully deployed position.

At step 920, the computing system will continually or periodically identify, determine and/or track the location of the wheelchair 250 and/or wheelchair passenger 250 based on input from any of the various perception systems available in/on the vehicle 102, including but not limited to perception sensor 802. Sensors present on the wheelchair 250 may also provide data concerning its location to the vehicle computing system. Aside from determining if and when the wheelchair passenger 250 is located in the wheelchair securement area (e.g., is properly positioned for securement in the wheelchair securement system 220) and then automatically proceeding to step 922, the computing system may also determine or detect unsafe conditions as the wheelchair passenger 250 attempts to enter the vehicle 102 and the wheelchair securement area. For instance, the computing system can be configured to detect: if the wheelchair 250 is either moving or pointing in the wrong direction (for example, toward the non-egress door 209); if the wheelchair passenger 250 has failed to enter the vehicle and/or the wheelchair securement area within a predetermined period of time; if the wheelchair 250 or wheelchair passenger 250 failed to move within a predetermined period of time; if the wheelchair passenger 250 is determined to have fallen asleep or fallen out of their wheelchair 250; if the wheelchair passenger 250 is attempting to enter through a non-ingress door 209; and/or, if the wheelchair 250 is moving into a dangerous position (e.g., approaching an edge of a ramp).

At step 922, the computing system may automatically command the wheelchair securement system 220 to engage with the wheelchair 250 and/or the wheelchair passenger 250. If the wheelchair securement system 220 includes components that need to be applied by the wheelchair passenger 250 or other occupant, visual or auditory alerts may be provided in the vehicle or through the rideshare app to remind the passenger to apply those safety restraints.

At step 924, the computing system may, perhaps after a predetermined period of time, check the status of the wheelchair securement system 220 to confirm that the wheelchair 250 and/or wheelchair passenger are secured in the wheelchair securement system. If not, the computing system may, perhaps spaced apart by predetermined periods of time, repeatedly or continuously check the status of the wheelchair securement system 220 and provide feedback to the vehicle occupants. Step 924 may include checking to ensure proper and safe engagement between the wheelchair securement system and the wheelchair 250 and wheelchair passenger 250. If the wheelchair securement system 220 includes components that need to be applied by the wheelchair passenger 250 or other occupant (e.g., wheelchair tiedowns, occupant restraints/safety belts, etc.), the computing system may automatically determine when those components have been applied and whether they were applied properly based on input from perception sensors or other sensors associated with the components themselves. For example, the computing system may detect whether occupant restraints are positioned properly against the wheelchair passenger's body (e.g., bearing in the bony structure region of the passenger's body; low across the front of the pelvis with the junction between lap and shoulder belts located near the passenger's hip; absence of twists in the belt; not held away from the passenger's body by wheelchair components or parts such as the wheelchair's wheels, armrests, panels or frame). In the case of wheelchair tiedowns, the computing system may detect whether the tiedowns are locked, without twists, connected at appropriate locations (e.g., near seat level, wheelchair frame members, and not plastic or removable parts of the wheelchair such as armrests) or pre-designated locations on the wheelchair, and oriented within an appropriate or predetermined range of angles, for example roughly 45° or between 30-45° for rear tiedowns and 40-60° for front tiedowns, or between roughly 30-60° for all tiedowns.

At step 926, the computing system automatically interlocks the wheelchair securement system 220 to prevent the wheelchair 250 and wheelchair passenger 250 from being released until the vehicle 102 has arrived at the appropriate destination. When interlocked, the computing system may be configured to reject or ignore any command or request to release the wheelchair 250 and/or wheelchair passenger 250 from the wheelchair securement system 220 and/or provide feedback or other warning to the vehicle occupants that an unsafe condition has been requested, in which case the vehicle occupant can be given the option to override the interlock. Interlocking the wheelchair securement system 220 will prevent the wheelchair 250 and wheelchair passenger 250 from being released while the vehicle is moving and when any open door lacks a properly deployed wheelchair access device.

At step 928, with the wheelchair 250 and wheelchair passenger 250 properly secured, the computing system will automatically remove the wheelchair access device 210 interlock and commands the wheelchair access device 210 to stow. Prior to removing that interlock and/or issuing that command, the computing system may confirm that the ingress door 208 and wheelchair access device 210 are clear of other passengers or other obstructions. While the wheelchair access device 210 is moving, the computing system may continue to monitor the area surrounding the ingress door 208 and/or the wheelchair access device 210 to ensure that they remain clear of passengers or other obstructions. See, for example, U.S. Patent Application No. 63/484,000, filed on Feb. 9, 2023, which discloses a perception based obstruction detection system that may be employed for these purposes and is incorporated herein by reference. The computing system may also monitor vehicle occupants and/or persons outside the vehicle for movement that suggests a person is moving toward the ingress door 208 and, responsive thereto, stop operation of the wheelchair access device 210. Perhaps after a predetermined period of time, the computing system checks the status of the wheelchair access device 210 to confirm that the wheelchair access device 210 is fully stowed. If not, the computing system may automatically issue another command for the wheelchair access device 210 to stow. In any event, the computing system may, perhaps spaced apart by predetermined periods of time, repeatedly or continuously check the status of the wheelchair access device 210 and only proceeds to step 930 when the stowed status of the wheelchair access device 210 is confirmed. Optionally, the computing system may interlock operation of the wheelchair access device 210 before proceeding to step 930.

At step 930, the computing system automatically removes the ingress door 208 interlock and automatically commands the ingress door 208 to close. Prior to removing that interlock and/or issuing that command, the computing system may confirm that the ingress door 208 is clear of other passengers or other obstructions. The computing system may additionally automatically remove the non-ingress door 209 interlock. The computing system may additionally, perhaps after a predetermined period of time, check the status of the ingress door 208 to confirm that the ingress door 208 is fully closed. If not, the computing system may automatically issue another command for the ingress door 208 to close. In any event, the computing system may, perhaps spaced apart by predetermined periods of time, repeatedly or continuously check the status of the ingress door 208 and only departs for a new destination when the closed status of the ingress door 208 is confirmed.

At any one or more of the steps of operation 900, the computing system (for instance, the internal computing system 110) may be configured to provide feedback of ingress status to any one or more of the remote computing system 150, the ride sharing app 170, the wheelchair passenger 250, other vehicle occupants, and other persons standing near the vehicle 102, through audible or visual alerts and/or pursuant to operation 400, including but not limited to steps 414, 416, and 418. For example, in step 902, an alert may be generated informing vehicle occupants that the wheelchair ingress operation has begun. Additionally, an alert may be generated instructing vehicle occupants to clear/move away from the wheelchair securement area. In step 904, an alert may be generated informing occupants that the non-ingress door needs to be closed. In step 906, an alert may be generated warning occupants that the non-ingress door should not be opened. In step 908, an alert may be generated informing occupants that the ingress door is opening. In steps 910 and 912, an alert may be generated informing occupants that the ingress door 208 needs to be opened and/or cannot be closed to allow wheelchair ingress. In step 914, an alert may be generated to warn all occupants that the wheelchair access device 210 is deploying and to stay clear of the ingress door 208, the wheelchair access device 210, and surrounding area while the wheelchair access device 210 is deploying. In step 916 and 918, an alert may be generated informing occupants that the wheelchair access device 210 needs to be deployed and cannot be stowed or moved to allow wheelchair ingress. In step 920, an alert may be generated informing occupants that it is safe for the wheelchair 250 and wheelchair passenger 250 to enter the vehicle and for other passengers to stay clear of the wheelchair passenger 250. At Step 922, an alert may be generated informing occupants that the wheelchair 250 and/or wheelchair occupant 250 will be secured by the wheelchair securement system 220. In step 924, an alert may be generated informing occupants that the wheelchair 250 and the wheelchair occupant 250 need to be secured by the wheelchair securement system 220 before the wheelchair access device 220 can be stowed, before ingress door 208 can be closed, and/or before the vehicle 102 can depart. Additional information may be provided directing the wheelchair passenger 250 to the wheelchair securement area, including visual information, such as illuminated arrows or other indicators on or near the wheelchair securement system 220 and/or on the floor of the vehicle. To the extent that the computing system detects that the wheelchair 250 is either moving or pointing in the wrong direction (for example, toward the doors 208, 209), an alert may be generated providing appropriate correction. At step 926, an alert may be generated informing occupants that the wheelchair securement system cannot be disengaged while the vehicle 102 is moving, while non-egress doors 209 are open, or before the wheelchair access device 210 is deployed. At step 928, an alert may be generated warning that the wheelchair access device 210 will be moving to the stow position and/or to not use the wheelchair access device 210 and/or the ingress door 208. Additionally, an alert may be generated informing occupants that the wheelchair access device 210 needs to be fully stowed before the vehicle 102 can depart. In step 930, an alert may be generated informing occupants that all doors 208, 209 are now operational and/or that the ingress door 208 is closing.

Further, at any one or more of the steps of operation 900, including but not limited to steps identified below, the computing system (for instance, the internal computing system 110) may be configured, for example based on input from any component sensors or perception sensors available in the vehicle, to identify fault states and/or provide feedback of such fault states to any one or more of the remote computing system 150, the ride sharing app 170, the wheelchair passenger 250, other vehicle occupants, and other persons standing near the vehicle 102, including through audible or visual alerts and/or pursuant to operation 400, including but not limited to steps 414, 416, and 418. A fault state may be any state, in which the WAV is unable to complete any step of the operation 900. For example, the computing system may include in the feedback that a fault state has been detected: in connection with step 902 because the passenger failed to issue an ingress command within a predetermined period of time after arriving at the passenger's pick-up location; in connection with step 904 because the non-ingress door 209 will not close or is obstructed; in connection with step 906 et seq. because an occupant or other person is commanding the non-ingress door 209 to open when it would be unsafe to do so; in connection with steps 908 and 910 because the ingress door 208 will not open or is obstructed from opening; in connection with step 912 et seq. because an occupant or other person is commanding the ingress door 208 to close when it would be unsafe to do so; in connection with steps 912, 914, 916, because an occupant or a person outside the vehicle is approaching or attempting to use the ingress door 208 before the wheelchair access device 210 is fully deployed; in connection with steps 914, 916 because the wheelchair access device 210 will not deploy or is obstructed from deploying; in connection with step 918 et seq. because an occupant or other person is commanding the wheelchair access device 210 to stow before the wheelchair passenger 250 has fully entered the vehicle; in connection with steps 920, 922, 924, because the wheelchair passenger 250 has failed to enter the vehicle or the wheelchair securement area within a predetermined period of time, failed to move within a predetermined period of time, is determined through AI to have fallen asleep or fallen out of their wheelchair 250, is attempting to enter or exit through a non-ingress door 209, and/or is moving into a dangerous position (e.g., approaching an edge of a wheelchair access device); in connection with steps 922, 924 because the wheelchair securement system 220 will not automatically engage with the wheelchair 250 or wheelchair passenger or because the wheelchair passenger 250 has failed to take any action necessary for it to engage therewith, such as applying an occupant restraint to their body (e.g., seat belts); in connection with step 926 et seq. because an occupant or other person is commanding the wheelchair securement system 220 to release the wheelchair 250 and/or wheelchair passenger before the vehicle is stopped, while the non-egress door 209 is open, and/or before the wheelchair access device 210 is deployed; in connection with step 928, because the wheelchair access device 210 will not stow or is obstructed from stowing; and, in connection with steps 928 and 930 because an occupant or a person outside the vehicle is approaching or attempting to use the wheelchair access device 210 and/or door 208 while moving/closing.

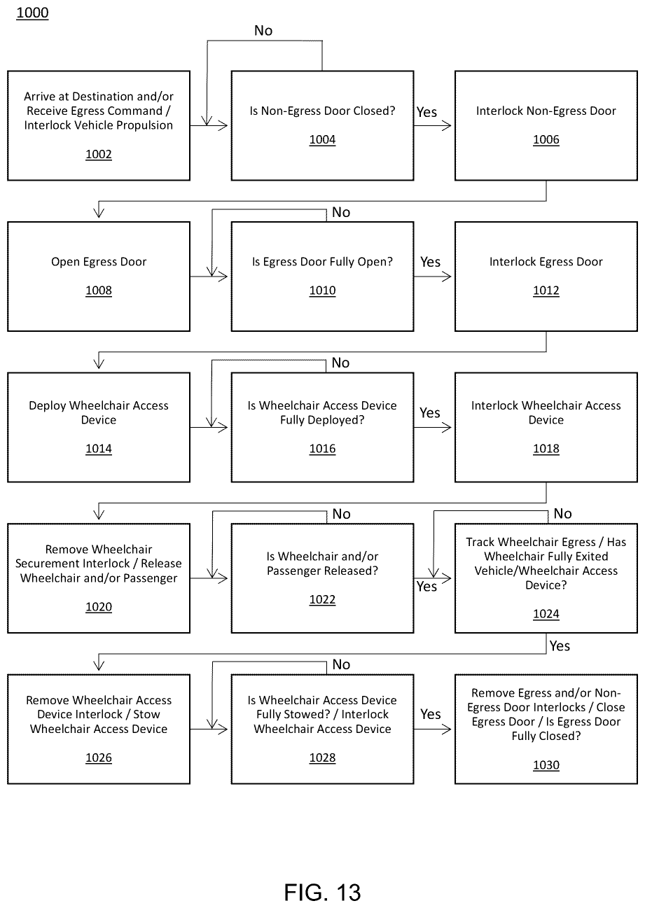

FIG. 13 is a simplified flow diagram illustrating example wheelchair egress operation 1000 that may be performed by one or more of the computing systems, e.g., remote computing system 150, internal computing system 110, and/or a separate computing system for the wheelchair accessibility system 140, in the wheelchair accessible autonomous vehicle 102 of FIGS. 1-11. Any combination of the steps in operation 1000 may be used in a given application, and those steps may be performed in any order. Moreover, it is contemplated that the computing system can be configured to automatically proceed from step to step upon satisfaction of the conditions prescribed for the preceding step and without human interaction or input.

Example wheelchair egress operation 1000 starts at step 1002, in which the computing system determines that the vehicle 102 has arrived at the wheelchair passenger's 250 destination and automatically proceeds to step 1004. In some embodiments, an interlock may be initiated preventing the vehicle 102 from moving for the remainder of the egress operation 1000, before step 1008 when the egress door is opened. In some embodiments, the computing system may also require receiving an egress request or command from the wheelchair passenger 250 before automatically proceeding to step 1004. It is contemplated that an egress command can comprise a request to release the wheelchair 250 and/or wheelchair passenger 250 from the wheelchair securement system 220, to open the egress door 208, or to deploy the wheelchair access device 210.

At step 1004, the computing system automatically checks the status of the non-egress door 209 to confirm that the non-egress door 209 is fully closed. If not, the computing system may automatically issue a command for the non-egress door 209 to close. In any event, the computing system may, perhaps spaced apart by predetermined periods of time, repeatedly or continuously check the status of the non-egress door 209 and only automatically proceeds to step 1006 when the closed status of the non-egress door 209 is confirmed. For the avoidance of doubt, the non-egress door 209 is any door in a vehicle through which the wheelchair passenger is not intended to depart. In some cases, a vehicle may have multiple doors that are wheelchair accessible. For purposes of this hypothetical vehicle, the accessible door through which the passenger is intended to depart at a specific destination is referred to herein as the egress door, while the remaining door(s) (whether wheelchair accessible or not) are collectively referred to as the non-egress door.

At step 1006, the computing system automatically interlocks the non-egress door 209 to prevent the door 209 from opening for at least a portion of the egress operation 1000. For example, the computing system may be configured to automatically reject any command or request to open the non-egress door 209 and/or provide feedback or other warning to the vehicle occupants that an unsafe condition has been requested, in which case the vehicle occupant can be given the option to override the interlock. Interlocking the non-egress door 209 prevents an unsecured wheelchair 250 from exiting through an unintended door, which could be on the traffic side of the vehicle, and/or through a door lacking a wheelchair access device.

At step 1008, the computing system automatically commands the egress door 208 to open. At step 1010, perhaps after a predetermined period of time, the computing system checks the status of the egress door 208 to confirm that the egress door 208 is fully open. If not, the computing system may automatically issue another command for the egress door 208 to open. In any event, the computing system may, perhaps spaced apart by predetermined periods of time, repeatedly or continuously check the status of the egress door 208 and only proceeds to step 1012 when the open status of the egress door 208 is confirmed.

At step 1012, to prevent undesirable interference between the egress door 208 and the wheelchair access device 210, the computing system automatically interlocks the egress door 208 to prevent the door 209 from closing for at least a portion of the egress operation 1000. For example, the computing system may be configured to reject any command or request to close the egress door 208 and/or provide feedback or other warning to the vehicle occupants that the door 208 cannot be closed while the wheelchair access device 210 is deployed or deploying, in which case the vehicle occupant can be given the option to stow the wheelchair access device 210 and override the interlock.

At step 1014, the computing system automatically commands the wheelchair access device 210 to deploy. If necessary, the computing system will first remove any interlocks for the wheelchair access device 210 that may prevent its operation. Additionally, prior to removing that interlock and/or issuing that command, the computing system may confirm that the egress door 208 and wheelchair access device 210 are clear of other passengers or obstructions. While the wheelchair access device 210 is moving, the computing system may continue to monitor the area surrounding the egress door 208 and/or the wheelchair access device 210 to ensure that they remain clear of passengers or other obstructions. See, for example, U.S. Patent Application No. 63/484,000, filed on Feb. 9, 2023, which discloses a perception based obstruction detection system that may be employed for these purposes and is incorporated herein by reference. The computing system may also monitor vehicle occupants and/or persons outside the vehicle for movement that suggests a person is moving toward the egress door 208 and, responsive thereto, stop operation of the wheelchair access device 210. For the avoidance of doubt, for the egress operation 1000, it is contemplated that the deployed position of a wheelchair access device is the position in which the wheelchair passenger 250 can safely be received by the wheelchair access device from the interior of the vehicle.

At step 1016, perhaps after a predetermined period of time, the computing system checks the status of the wheelchair access device 210 to confirm that the wheelchair access device 210 is fully deployed. If not, the computing system may automatically issue another command for the wheelchair access device 210 to deploy. In any event, the computing system may, perhaps spaced apart by predetermined periods of time, repeatedly or continuously check the status of the wheelchair access device 210 and only proceeds to step 1018 when the deployed status of the wheelchair access device 208 is confirmed.

At step 1018, the computing system automatically interlocks the wheelchair access device 210 to prevent the wheelchair access device 210 from moving and/or stowing for at least a portion of the egress operation 1000. For example, the computing system may be configured to reject or ignore any command or request to stow the wheelchair access device 210 and/or provide feedback or other warning to the vehicle occupants that an unsafe condition has been requested, in which case the vehicle occupant can be given the option to override the interlock. Interlocking the wheelchair access device 210 prevents an unsecured wheelchair 250 from exiting through the egress door 208 without the wheelchair access device 210 in its fully deployed position.

At step 1020, with the non-egress door 209 interlocked in the closed position, the egress door 208 interlocked in the open position, and the wheelchair access device interlocked in the deployed position, the computing system may remove a wheelchair securement interlock preventing operation of the wheelchair securement system 220, if necessary, and then automatically command the wheelchair securement system 220 to release/disengage from the wheelchair 250 and/or the wheelchair passenger 250.

At step 1022, the computing system may, perhaps after a predetermined period of time, check the status of the wheelchair securement system 220 to confirm that the wheelchair 250 and/or wheelchair passenger are free from their restraints. If not, the computing system may, perhaps spaced apart by predetermined periods of time, repeatedly or continuously check the status of the wheelchair securement system 220 and provide feedback to the vehicle occupants.

At step 1024, the computing system will continually or periodically identify, determine and/or track the location of the wheelchair 250 and/or wheelchair passenger 250 based on input from any of the various perception systems available in/on the vehicle 102, including but not limited to perception sensor 802. Sensors present on the wheelchair 250 may also provide data concerning its location to the vehicle computing system. Aside from determining if and when the wheelchair passenger 250 has exited the vehicle 102 and then automatically proceeding to step 1026, the computing system may also determine or detect unsafe conditions as the wheelchair passenger 250 attempts to exit the vehicle 102. For instance, the computing system can be configured to detect: if the wheelchair 250 is either moving or pointing in the wrong direction (for example, toward the non-egress door 209); if the wheelchair passenger 250 has failed to exit the vehicle within a predetermined period of time; if the wheelchair 250 or wheelchair passenger 250 failed to move within a predetermined period of time; if the wheelchair passenger 250 is determined to have fallen asleep or fallen out of their wheelchair 250; if the wheelchair passenger 250 is attempting to exit through a non-egress door 209; and/or, if the wheelchair 250 is moving into a dangerous position (e.g., approaching an edge of a wheelchair access device).

At step 1026, the computing system automatically removes the wheelchair access device 210 interlock and automatically commands the wheelchair access device 210 to stow. Prior to removing the interlock and/or issuing that command, the computing system may confirm that the egress door 208 and wheelchair access device 210 are clear of other passengers or other obstructions. While the wheelchair access device 210 is moving, the computing system may continue to monitor the area surrounding the egress door 208 and/or the wheelchair access device 210 to ensure that they remain clear of passengers or other obstructions. See, for example, U.S. Patent Application No. 63/484,000, filed on Feb. 9, 2023, which discloses a perception based obstruction detection system that may be employed for these purposes and is incorporated herein by reference. The computing system may also monitor vehicle occupants and/or persons outside the vehicle for movement that suggests a person is moving toward the egress door 208 and, responsive thereto, stop operation of the wheelchair access device 210.

At step 1028, perhaps after a predetermined period of time, the computing system checks the status of the wheelchair access device 210 to confirm that the wheelchair access device 210 is fully stowed. If not, the computing system may automatically issue another command for the wheelchair access device 210 to stow. In any event, the computing system may, perhaps spaced apart by predetermined periods of time, repeatedly or continuously check the status of the wheelchair access device 210 and only proceeds to step 1030 when the stowed status of the wheelchair access device 210 is confirmed. Optionally, the computing system may interlock operation of the wheelchair access device 210 before proceeding to step 930.

At step 1030, the computing system automatically removes the egress door 208 interlock and automatically commands the egress door 208 to close. Prior to removing that interlock and/or issuing that command, the computing system may confirm that the egress door 208 is clear of other passengers or other obstructions. The computing system may additionally automatically remove the non-egress door 209 interlock. The computing system may additionally, perhaps after a predetermined period of time, check the status of the egress door 208 to confirm that the egress door 208 is fully closed. If not, the computing system may automatically issue another command for the egress door 208 to close. In any event, the computing system may, perhaps spaced apart by predetermined periods of time, repeatedly or continuously check the status of the egress door 208 and only departs for a new destination when the closed status of the egress door 208 is confirmed.

At any one or more of the steps of operation 1000, the computing system (for instance, the internal computing system 110) may be configured to provide feedback of egress status to any one or more of the remote computing system 150, the ride sharing app 170, the wheelchair passenger 250, other vehicle occupants, and other persons standing near the vehicle 102, through audible or visual alerts and/or pursuant to operation 500, including but not limited to steps 508, 510, and 512. For example, in step 1002, an alert may be generated informing vehicle occupants that the wheelchair egress operation has begun. In step 1004, an alert may be generated informing occupants that the non-egress door needs to be closed. In step 1006, an alert may be generated warning occupants that the non-egress door should not be opened. In step 1008, an alert may be generated informing occupants that the egress door is opening. In steps 1010 and 1012, an alert may be generated informing occupants that the egress door 208 needs to be opened and/or cannot be closed to allow wheelchair egress. In step 1014, an alert may be generated to warn all occupants that the wheelchair access device 210 is deploying and to stay clear of the egress door 208, the wheelchair access device 210, and surrounding area while the wheelchair access device 210 is deploying. In step 1016 and 1018, an alert may be generated informing occupants that the wheelchair access device 210 needs to be deployed and cannot be stowed or moved to allow wheelchair egress. In step 1020, an alert may be generated informing occupants that the wheelchair 250 and/or wheelchair occupant 250 will be released from the wheelchair securement system 220. In step 1022, an alert may be generated informing occupants that the wheelchair 250 and the wheelchair occupant 250 need to be released from the wheelchair securement system 220 to allow wheelchair 250 egress. In step 1024, an alert may be generated informing occupants that it is safe for the wheelchair 250 and wheelchair passenger 250 to exit the vehicle and for other occupants to stay clear of the wheelchair passenger 250. Additional information may be provided directing the wheelchair passenger 250 to the egress door 208, including visual information, such as illuminated arrows or other indicators on or near the egress door 208, the wheelchair access device 210, and/or on the floor of the vehicle. To the extent that the computing system detects that the wheelchair 250 is either moving or pointing in the wrong direction (for example, toward the non-egress door 209), an alert may be generated providing appropriate correction. At step 1026, an alert may be generated for the remaining occupants warning that the wheelchair access device 210 will be moving to the stow position and/or to not use the wheelchair access device 210 and/or the egress door 208. In step 1028, an alert may be generated informing occupants that the wheelchair access device 210 needs to be fully stowed before the vehicle 102 can depart. In step 1030, an alert may be generated informing occupants that all doors 208, 209 are now operational and/or that the egress door 208 is closing.

Further, at any one or more of the steps of operation 1000, including but not limited to steps identified below, the computing system (for instance, the internal computing system 110) may be configured, for example based on input from any component sensors or perception sensors available in the vehicle, to identify fault states and/or provide feedback of such fault states to any one or more of the remote computing system 150, the ride sharing app 170, the wheelchair passenger 250, other vehicle occupants, and other persons standing near the vehicle 102, including through audible or visual alerts and/or pursuant to operation 500, including but not limited to steps 508, 510, and 512. A fault state may be any state, in which the WAV is unable to complete any step of the operation 1000. For example, the computing system may include in the feedback that a fault state has been detected: in connection with step 1002 because the passenger failed to issue a command to release the wheelchair within a predetermined period of time after arriving at the passenger's destination; in connection with step 1004 because the non-egress door 209 will not close or is obstructed; in connection with step 1006 et seq. because an occupant or other person is commanding the non-egress door 209 to open when it would be unsafe to do so; in connection with steps 1008 and 1010 because the egress door 208 will not open or is obstructed from opening; in connection with step 1012 et seq. because an occupant or other person is commanding the egress door 208 to close when it would be unsafe to do so; in connection with steps 1012, 1014, 1016, because an occupant or a person outside the vehicle is approaching or attempting to use the egress door 208 before the wheelchair access device 210 is fully deployed; in connection with steps 1014, 1016 because the wheelchair access device 210 will not deploy or is obstructed from deploying; in connection with step 1018 et seq. because an occupant or other person is commanding the wheelchair access device 210 to stow before the wheelchair passenger 250 has fully exited the vehicle; in connection with steps 1020, 1022 because the securement system 220 will not automatically disengage from the wheelchair 250 or wheelchair passenger or because the wheelchair passenger 250 has failed to take any action necessary for it to disengage therefrom, such as removing an occupant restraint from their body (e.g., seat belts); in connection with steps 1020, 1024, because the wheelchair passenger 250 has failed to exit the vehicle within a predetermined period of time, failed to move within a predetermined period of time, is determined through AI to have fallen asleep or fallen out of their wheelchair 250, is attempting to exit through a non-egress door 209, and/or is moving into a dangerous position (e.g., approaching an edge of a ramp); in connection with steps 1026, 1028, because the wheelchair access device 210 will not stow or is obstructed from stowing; and, in connection with steps 1026, 1028, and 1030 because an occupant or a person outside the vehicle is approaching or attempting to use the wheelchair access device 210 and/or door 208 while moving/closing.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

In one such departure, a vehicle may be provided with a wheelchair access device that can be deployed before the ingress/egress door needs to open. In such a case, the order of steps 908-912/1008-1012 and 914-918/1014-1018 of operations 900, 100 may be swapped, whereby the wheelchair access device will be deployed and interlocked before the ingress/egress door is opened and interlocked. Similarly, the order of steps 928/1028 and 930/1030 may be swapped, whereby the ingress/egress door will be closed before the wheelchair access device is stowed and interlocked.

In another such departure, any one or more of the following interlocking rules, which are based upon operations 900, 1000, may be employed in a vehicle to increase safety for a wheelchair passenger: when a non-ingress/egress door is open, the wheelchair securement system can be interlocked to prevent a wheelchair passenger from being released from securement; when a wheelchair is present in the vehicle and unsecured by the wheelchair securement system, the non-ingress/egress door can be interlocked to prevent it from opening; when a wheelchair is present in the vehicle and unsecured by the wheelchair securement system, the wheelchair access device can be interlocked in the deployed position to prevent it from stowing; when the wheelchair access device is deployed, the ingress/egress door can be interlocked in the open position to prevent it from closing on the wheelchair access device; when the wheelchair access device is not fully deployed and the ingress/egress door is open, the wheelchair securement system can be interlocked to prevent a wheelchair passenger from being released from securement; when a wheelchair is not detected in the vehicle, an interlock preventing operation of the non-ingress/egress door can be removed; when a wheelchair is determined to be present in the wheelchair securement area and/or stationary in the vehicle, the wheelchair access device can be automatically triggered to stow and the ingress door can close; when a vehicle has arrived at a wheelchair pick-up location, the ingress door will not open and/or the wheelchair access device will not deploy until it is determined that the wheelchair securement area is clear of other passengers.

1. A system for facilitating ingress and egress of a wheelchair in a wheelchair accessible vehicle, the system comprising:
one or more processors;
at least one door being moveable between an open position and a closed position;
a wheelchair access device associated with one of the at least one door and being moveable between a deployed position and a stowed position;
a wheelchair securement system for securing at least one of the wheelchair and a wheelchair passenger and having a secured condition and an unsecured condition; and,
a non-transitory computer-readable medium coupled to the one or more processors, wherein the computer readable medium comprises instructions, which when executed by the one or more processors, cause the one or more processors to perform operations comprising:
monitoring at least one of a vehicle status, a door status, a wheelchair access device status, a wheelchair securement system status, and a wheelchair status, wherein the wheelchair status comprises at least one of a location, a speed, and a direction of the wheelchair;
initiating at least one interlock function that locks or unlocks at least one of the wheelchair accessible vehicle, one of the at least one doors, the wheelchair access device, and the wheelchair securement system based at least in part upon at least one of:
(a) the wheelchair status;
(b) the door status;
(c) the wheelchair access device status;
(d) the wheelchair securement system status; and,
(e) the vehicle status.
